(19) United States
(12) Patent Application Publication
(10) Pub. No.: US 2002/0010584 A1
(43) Pub. Date: Jan. 24, 2002

(54) Interactive voice communication method and system for information and entertainment

(76) Inventors: Mitchell Jay Schultz, Huntington Station, NY (US); Aron Mayer Laikin, Plainview, NY (US); Frank Michael Yandolion, New York, NY (US); Steven Alan Hartman, Woodbury, NY (US)

Correspondence Address: WHITE & CASE LLP, PATENT DEPARTMENT, 1155 AVENUE OF THE AMERICAS, NEW YORK, NY, 10036, US

(21) Appl. No.: 09/862,579

(22) Filed: May 22, 2001

Related U.S. Application Data
(60) Provisional application No. 60/206,649, filed on May 24, 2000.

(51) Int. Cl. G10L 21/00; G10L 11/00

(52) U.S. Cl. 704/270

(57) ABSTRACT

The invention relates to an interactive voice communication method and system for communicating with personalities. Any sort of real or authored personality, including but not limited to celebrities, characters, and service personnel types, may be the object of the interaction provided by the invention. The system and method of the invention permits communication between a user and the personality, i.e., between a fan of a celebrity and the celebrity, or between a consumer and a virtual service-person, via telephone, audio, video, CD, DVD, Internet, stand-alone kiosks and wireless devices through use of voice response technology including speech recognition and natural language software.

This application claims the benefit of U.S. Provisional Patent Application Serial No. 60/ 206,649, filed May 24, 2000.

### FIELD OF THE INVENTION

The Invention relates to an interactive voice communication method and system, referred to as StarPlayer or Plug-In Player herein, for speaking with virtual persons or characters over the telephone, CD, DVD, Internet, Wireless or remote kiosks. Multi-media products and services are produced through its platform of integrated Interactive Voice Recognition (IVR) technologies, Artificial Intelligence (AI), 3D Animation as well as Audio and Video streaming technologies that exploit new advances in the convergence of entertainment, communications and new media.

### BACKGROUND OF THE INVENTION

The interaction between celebrities, i.e., entertainers or athletes, and their fans has evolved and grown significantly over the years. In particular, the amount and quality of personal contact that the fans want or expect to have with famous personalities has increased. Once, the only way to hear, view or experience an entertainer, celebrity, “star” or athlete was for the fan to physically be in the same locale as the entertainer, celebrity or athlete. With the advent of radio and television, a fan no longer had to physically be in the same place as the entertainer, celebrity or athlete to see or hear him or her, but the interaction still remained limited to specific times that the celebrity appeared. There was no provision for a spontaneous discussion initiated by the fan.

With the introduction of video, CD, DVD, wireless and now the Internet, a person can hear, view or experience a virtual person, celebrity or athlete at almost any time or any place they desire. Nevertheless, even with all the various ways for a person to hear, view or experience their favorite celebrity or athlete, or for a celebrity or athlete to reach or communicate with their fans, the experience is still quite limited. There is no interaction between the celebrity or athlete and a fan unless they are physically together. Furthermore, there is no dialogue between the celebrity and the fan and this limited interaction can leave a fan feeling dissatisfied with his or her experience.

In response to the desire of fans to converse or interact with a celebrity without both parties physically being in the same locale or actually speaking to each other live, one solution has been to use a pre-recorded response system. However, pre-recorded responses prompted by a telephone user's keypad input or touch tones provide an extremely limited way for a caller to interact with a celebrity. The limited pre-recorded voice response systems do not allow for a caller or user to ask any desired question. Rather, the recording simply requests that a caller or user to choose a pre-selected option and press a button to hear the desired communication. With a touch-tone interface, a record store, for instance, is limited to prompting callers to say or press #1 for Rock, #2 for Pop and #3 Jazz. Even in combination with a natural speech interface wherein a user/caller can tell the system “I would like the most recent CD by Aerosmith,” or “Aerosmith, please,” or “a good new Rock'n Roll CD with the single called ‘Nine Lives’, the responses are pre-recorded and permit a limited range of inquiries” Examples of pre-recorded response systems are also common in automated airline or ticket reservation and purchase systems. Such pre-recorded response systems also fail to provide a network for access to multiple celebrity voices selectable by the user in an entertainment network.

Use of prepaid calling cards or phone cards is known as a means to carry credit to place and concurrently pay for telephone calls from public, business or residential telephones. However such cards do not provide fans of a celebrity with a platform for direct access to the celebrity. Nor do they provide data about the user for marketing and pricing purposes by the celebrity or the developer of the entertainment network or its affiliates. Traditional calling cards do not operate like a direct pass for access to the celebrity.

### SUMMARY OF THE INVENTION

The present invention provides an interactive communication and entertainment network or system for a user to communicate and interact with a representation of celebrities (for example, famous personalities, athletes, politicians, authors, entertainers, fictional characters, animated and cartoon characters) by telephone, audio, video, CD, DVD, wireless, Internet and remote kiosk. The invention utilizes voice response technology including speech recognition and natural language software to detect and interpret a comment by the user as an inquiry to the celebrity. The interactive system of the present invention may be accessed by various means including prepaid phone interaction card or debit card, CD, DVD wireless, Internet and remote kiosk.

The present invention provides a computerized method for enabling a user, such as a fan of a celebrity, to interact with a representation of the celebrity. The method involves storing pre-recorded celebrity responses and voice samples in a database, including the celebrity's responses to a series of specific questions. The method prompts the user, who has access to the celebrity via telephone line, CD, DVD wireless, Internet and remote kiosk, to ask a question of the celebrity in normal speech. That speech is then detected using speech recognition programs and interpreted using natural language processing so that the user's true question or inquiry can be determined. Once that inquiry is determined it is processed along with the stored data to generate a celebrity response to the inquiry which is then provided to the user in the celebrity's own voice.

In another embodiment, the invention provides a method of creating a database of celebrity responses to commonly asked questions. The method involves conducting one or more focus groups made up of a sample of the public to generate one or more sets of questions commonly asked of the celebrity. An interview of the celebrity is then recorded during which the celebrity responds to one or more of those questions. A voice sample of the celebrity is also recorded using Concatinate Synthesis technology which incorporates text to speech, and also using voice to voice speech recognition software. The interview responses and voice samples are then stored in the database. The samples are then used to replicate the celebrity's voice with computer-generated responses such as tour dates, retail outlet locations, names of caller, holiday and occasion greetings, etc.

In another embodiment, the invention provides an entertainment network for communicating with a well-known personality including storing his or her voice responses in a database and then identify a user inquiry from a user of the network and responding to it using a stored response.

Users will also be able to navigate through the plug-in/player via a mouse/text or audio interface if they do not have a microphone or do not wish to use their voice. Some navigation options will include: Stopping Audio/Video and Entering Text Based Questions.

The StarPlayer has a ‘User Administration’ component giving the ability to assign users to different groups with permissions and rights to certain content. This feature will block minors from certain interactions or provide V.I.P. area access.

### DATA SERVICES

### Voice Database

The voice database will cache the pre-recorded personality responses used by the Interactive Voice Recognition (IVR) system. The database will be built using, as an example, Oracle 8i and maintained in a server-based hardware architecture.

### User Database

The user database will house all of the user profile data including preferences, interactive sessions. This database will be the primary source for our Data mining efforts. Market analysis reports will be constructed based on the user experience in the StarPlayer system as it related to voice navigation and voice interactivity.

Data mining finds patterns and relationships in data by using sophisticated techniques to build models which are abstract representations of reality. Databases today can range in size into the terabytes, i.e., more than 1,000,000,000,000 bytes of data. Within these masses of data lies hidden information of strategic importance.

Data mining is only one step in the knowledge discovery process. Other steps include identifying the problem to be solved, collecting and preparing the right data, interpreting and deploying models, and monitoring the results.

### Managed Documents

VoxML: These documents will be used to index all the voice files including pre-recorded and real-time voice interactions. The indexing may also be of benefit in facilitating interaction with other voice browsers.

StarXML: These documents will store all 3D character creation profiles including face, body and lip-syncing information. These documents will be based on specific XML DTD that we supply and may be used in the future by other third party vendors for integration purposes.

### BRIEF DESCRIPTION OF THE DRAWINGS

FIG. 1 is a flow chart showing the sequence of operations of an embodiment of the present invention accessed by use of a prepaid phone interaction card.

FIG. 2 is a flow chart showing the sequence of operations of an embodiment of the present invention accessed by use of a CD or DVD.

FIG. 3 is a flow chart showing the sequence of operations for the production of voice responses in accordance with an embodiment of the present invention.

FIG. 4 is a flow chart showing the sequence of operations of another embodiment of the present invention accessed through the Internet.

FIG. 5 is a layout diagram of an embodiment of this invention.

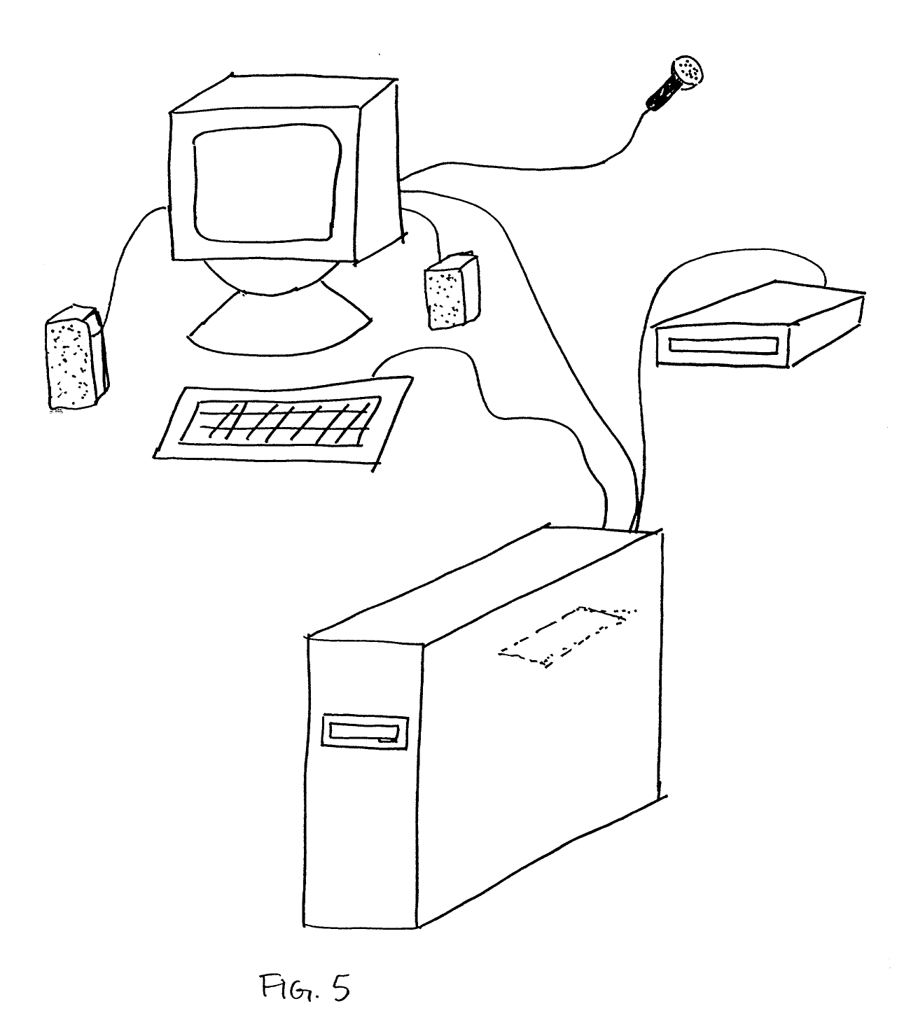

FIG. 6 is a schematic diagram showing devices for accessing the interactive system by using a telephone or by using a computer.

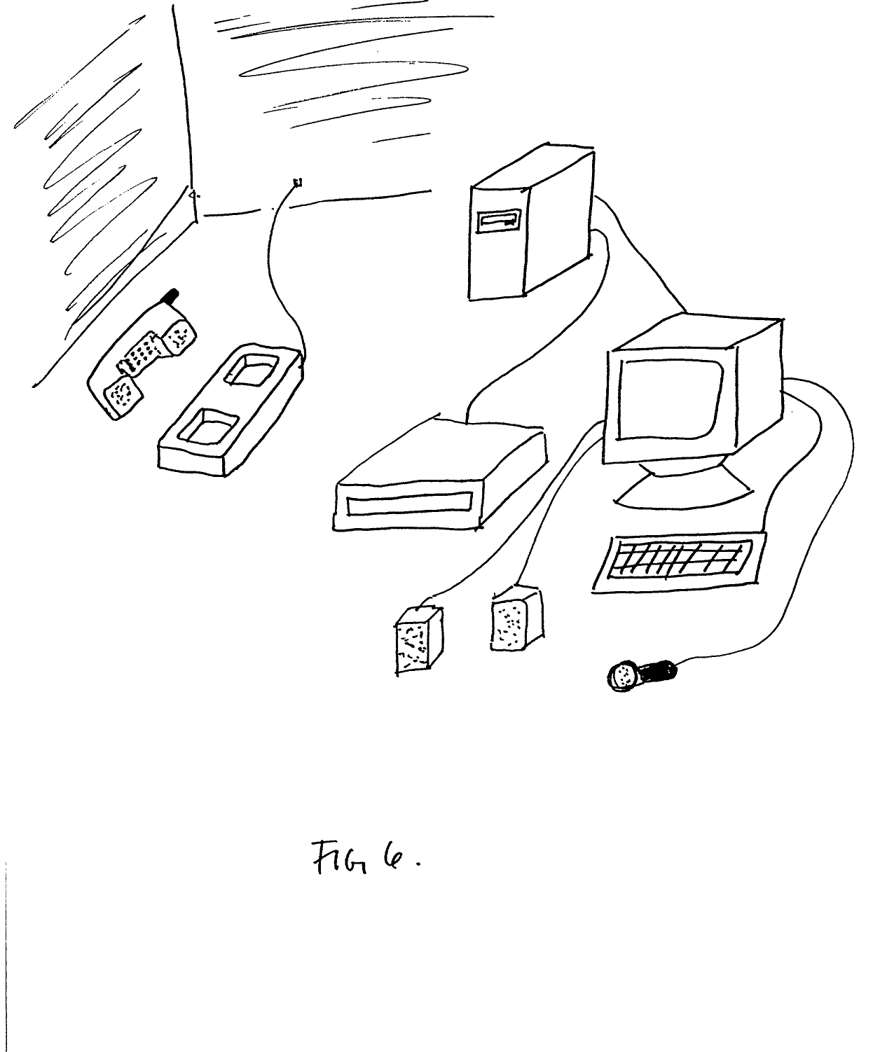

FIG. 7 is a CD/DVD (StarDisc) high-level operational schematic.

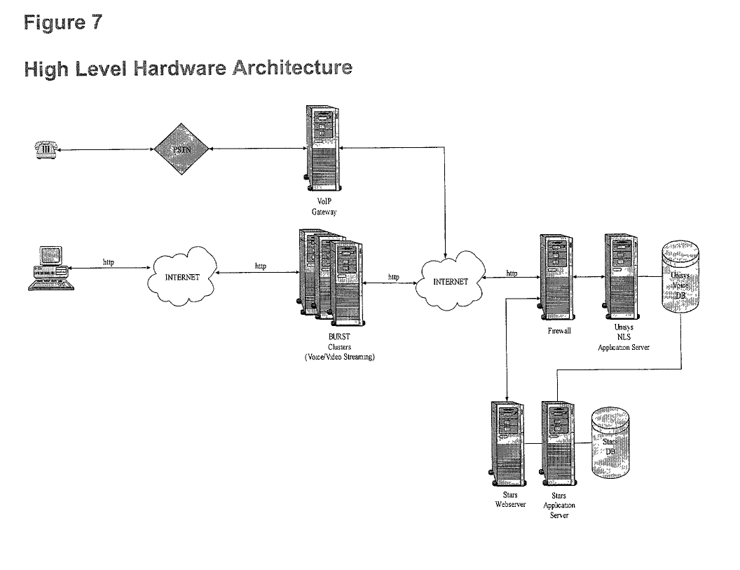

FIG. 8 is a telephony (StarPass) high-level operational schematic.

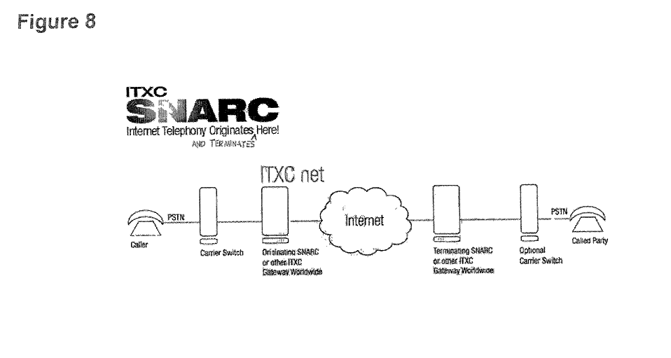

FIG. 9 is a telephony hardware architecture diagram.

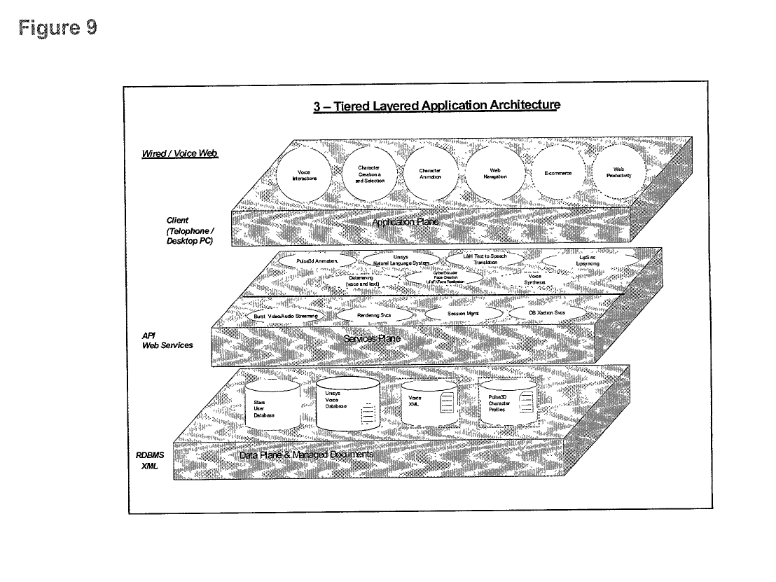

FIG. 10 is a 3-tiered layered application architecture overview.

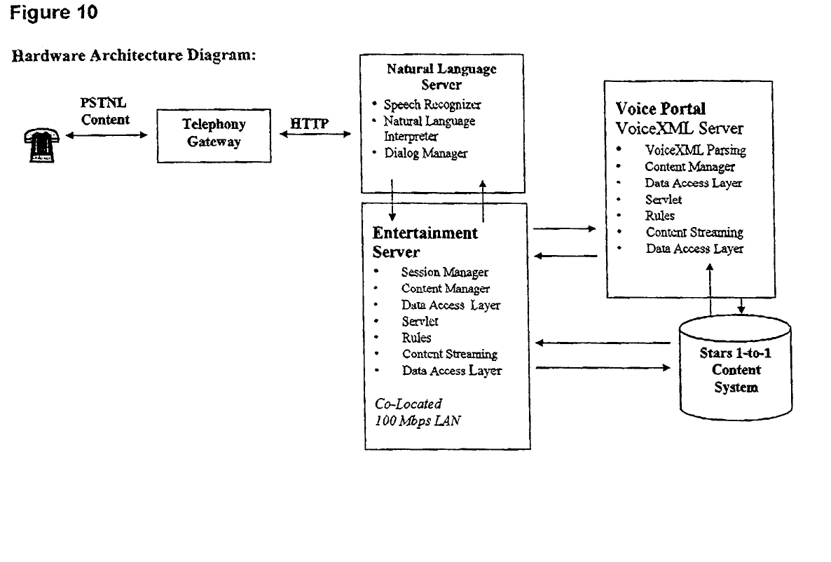

FIG. 11 is a Voice-over IP (VOIP) diagram.

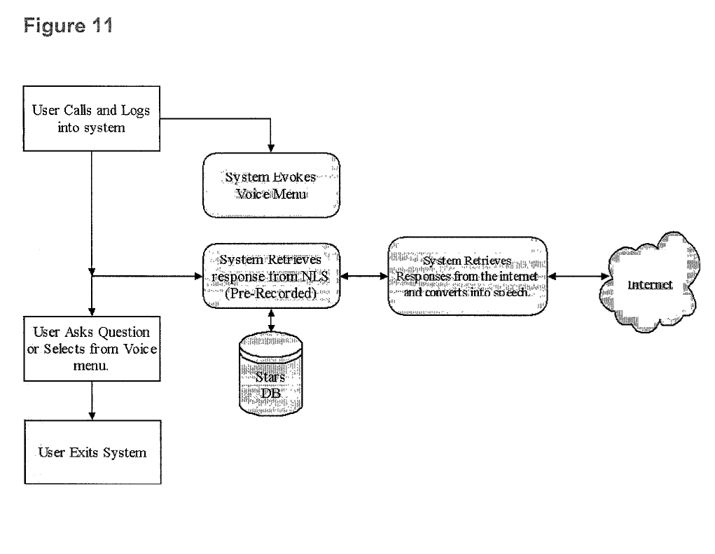

FIG. 12 is a high-level hardware architecture diagram for telephony and PC applications.

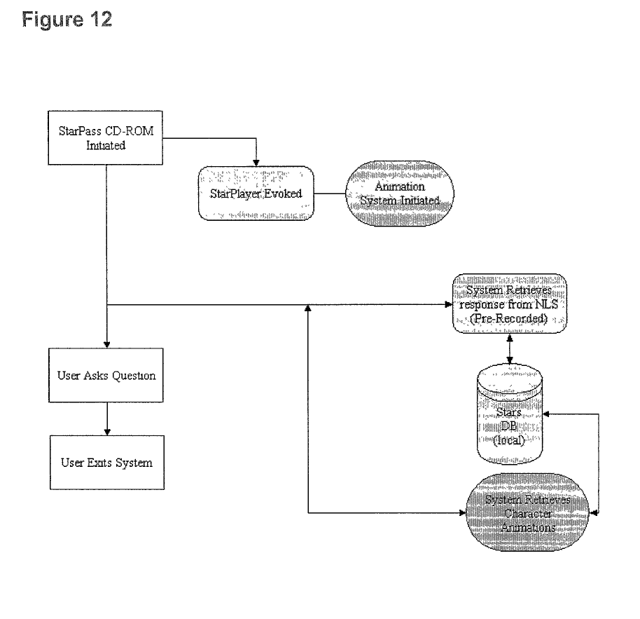

### DETAILED DESCRIPTION OF THE INVENTION

The invention relates to an interactive voice communication method and system for communicating with personalities. Any sort of real or authored personality, including but not limited to celebrities, characters, and service personnel types, may be the object of the interaction provided by the invention. The system and method of the invention permits communication between a user and the personality, i.e., between a fan of a celebrity and the celebrity, or between a consumer and a virtual service-person, via telephone, audio, video, CD, DVD, Internet, stand-alone kiosks and wireless devices through use of voice response technology including speech recognition and natural language software.

The StarPlayer system encompasses a customized media that has a proprietary plug-in player to display the audio and visual interactions. This plug in/player manages and routes various multi-media technologies used to run a voice-activated interaction over the Internet and wireless devices. The open-architecture, java-based platform will seamlessly integrate the necessary drivers of the interactivity and control the flow of information between the user and the servers. After the information has been properly routed and transferred back and forth, selected data is then captured and with the use of custom artificial intelligence, the interaction is directed in a very personalized manner. Some of this recorded information can be selected and converted into text via dictation software. The intonations and nuances of the user's voice is rated and flagged based on the resonance and timber enabling more specific responses in real-time. This plug-in/player is designed to be compatible with standard media players currently on the market today such as, Real Player, Window's Media Player and Quick Time Player. There is a one time only download of the plug-in onto the user's desktop to enable this interactive experience.

Voice recognition is delivered via the StarPlayer whereby, using a combination of voice recognition and response technology and streaming audio and video, users can hold a “virtual” audio-visual conversation with certain Personalities featured on the Internet Website, wireless or remote kiosk. This application allows the user to access updated information from the Internet and link to other related information resources. Users can navigate the Website with their standard computer microphone using simple voice commands such as “take me to the music area.” Once in the “music area,” the user may control his/her own interaction with a celebrity or site host of their choice.

An example of a technology that the StarPlayer can use is Unisys Natural Language Suite which incorporates limited artificial intelligence (AI) technology. However, for a more conversational voice interaction, a more sophisticated AI from such companies available from providers such as Poly Information Systems will be used. Poly has a software system that enables computers to understand a human vocalized request in normal, everyday language. This behavioral network is set up in a similar fashion to the human brain, where categories or trees are laid out with sub categories or branches of knowledge available for quick response to naturally spoken commands.

One embodiment of the invention, which is directed to the consumer market is Stars 1-to-1 Interactive Entertainment Network (Stars 1-to-1), a virtual Celebrity Hotline for end-users to acquire the most up-to-date, ‘behind-the-scenes’ information about their favorite celebrities, spoken in the stars' own voices. This interface allows a fan to ask celebrities questions in a natural conversational format and participate in voice-interactive contests and promotions. The fan's questions and comments will simultaneously be directed to purchase products from Stars 1-to-1 or its affiliates over the telephone or the Internet. These interactions will be processed by Stars 1-to-1's marketing vehicles such as StarPass (Backstage pass-type interactive telephony card), StarDisc (CD or DVD visual/audio disc) and the StarPlayer (Internet Plug-in/player over Stars1to1.com.). Advantageously, Stars 1-to-1, provides an avenue for targeting the worldwide tween/teen market.

Referring now to the figures, wherein like reference numerals designate identical or corresponding parts, it will be appreciated that through the use of voice recognition technology, a user may simulate a conversation with a well-known personality (celebrity) without the necessity of the personality participating live or in the same locale. The term celebrity refers to any well-known personality such as a sports or entertainment star, a cartoon or fictional character or other famous character, virtual sales, customer service or website host or celebrity. The term user refers to a person who utilizes the method or system of the invention to have a conversation or other interaction with a celebrity. The user may be referred to as a fan or, in the case of telephone access to the celebrity, a caller. One embodiment of the present invention provides an entertainment network where a fan or user can interact or converse with a star or celebrity.

The entertainment network is a computerized network that permits the use of voice activation to communicate a question to the famous personality. Such a question may be transmitted over phone lines, including via use of a pre-paid telephone calling card or may alternatively be accessed via CD or DVD, wireless, remote kiosk or via the Internet. The entertainment network utilizes speech recognition software (SR) to capture or detect the fan's speech and uses natural language software (NL) to analyze the results of the SR to generate the fan's inquiry.

SR is software that has the ability to audibly detect human speech and parse it in order to generate a string of words, sounds or phonemes to represent what a person said. The computer recognizes words from human speech by using a series of algorithms that process the raw acoustical signal to extract features, classify phonemes, and recognize words. Digitizing and segmenting algorithms convert the raw audio signals to segments; while Fourier, cepstral, and linear predictive analysis algorithms extract features such as fundamental frequencies and formats. Classifying algorithms process the features to generate phonemes, which are then combined and interpreted into words. Generally, phonemes are the sounds made by one or more letters in sequence with other letters. When SR has broken out sounds into phonemes and syllables, a “best guess” algorithm is used to map the phonemes and syllable into actual words. A commercially available SR package which can be used is Speech Recognizer (Nuance Communications, Inc.).

NL is software that analyzes speech and generates a voice response. For example, U.S. Pat. No. 5,995,918 to Kendal et al., incorporated herein by reference, describes an NL system and method for creating a language grammar using a spreadsheet or table interface. NL analyzes the speech, which has been digitized into text by the SR operation to determine the meaning and variable choices. The intelligence of NL automatically processes, in real-time, phrases such as “next Friday,” “tomorrow,” “today” for dates or “100 dollars,” “100 bucks”, or “160 francs” for monetary amounts.

NL processes the output from SR and ‘understands’ what the user meant. NL then translates the user's command into an actual machine command and generates a response. A response is generated in the following manner. A famous personality first pre-records a battery of all possible audio and/or visual responses for inclusion into a database. The NL analysis of the SR output determines which pre-recorded response is appropriate and prompts such response in a real-time manner, resulting in a natural conversational feel to the interaction. NL determines which response is appropriate rather than the fan or user making the determination and prompting the response by pressing a keypad as in pre-recorded response systems. Hence, NL enables computer or telephone-based applications with a more natural “listen and feel.”

Commercially available NL software made by Unisys Corporation under the tradename Natural Language Speech Assistant 4.0 (NLSA) is a suitable type of NL software for use in the claimed method and system. Unisys Corporation's Natural Language Speech Assistant (NLSA) is an advanced speech application development software package that provides application developers with software for speech application design and creation as well as for application project management, development methodology and testing. NLSA provides developers an open tool to design and develop spoken language applications across platforms and speech recognizers. Unisys' NLSA is platform and speech recognizer-independent. Therefore, a variety of different SR software can be used in conjunction with NLSA.

NLSA includes speech application simulation, application project management, development methodology, grammar generation and run-time interpretation. Unisys' NLSA analyzes the speech, which has been digitized into text by the system, to determine the meaning and variable choices. Part of the Unisys Natural Language Understanding suite of products, NLSA includes speech application simulation, application project management, development methodology, grammar generation and run-time interpretation. All responses are in the celebrity's own voice which is computer generated using natural language voice recognition technology. One embodiment of the present invention uses Nuance Communications, Inc. SR combined with NLSA to create a more robust voice response application.

By using Concatinate Synthesis technology and a voice sample of a celebrity's voice, an artificial intelligence of the celebrity is created to allow an in-depth talk with the user without having to anticipate his every question. Concatinate Synthesis technology replicates individuals' voices using stored voice samples which are then prompted by use of speech recognition technology. The Lernout and Hauspie company has a software program for Concatinate Synthesis that is suitable for use with the method and system of the invention. Limited voice-sampling is done with the celebrity to update information such as concert dates which can be read off in the celebrity's own voice without requiring the celebrity to pre-record it.

The combination of SR and NL facilitates comprehension. For example, an SR package asks an NL package if it thinks the “tue” sounds means “to,” “two” or “too,” or if it is part of a larger word such as “tutelage.” The NL package makes a suggestion to the SR package by analyzing what seems to make the most sense given the context of what the user has previously said. It could work the other way around as well. For example, an NL package queries an SR package to see if a user emphasizes a certain word or phrase in a given sentence. The NL package realizes when a user emphasizes certain words and thereby more accurately determines what the user wants (e.g., the sentence “I don't like that!” differs subtly, yet importantly, from the sentence “I don't like that”).

SR determines which sounds or words were emphasized. This is accomplished by analyzing the volume, tone, and speed of the phonemes that are spoken by the caller and reporting that information back to the NL package. SR and NL makes the human-computer interaction abstract, eliminating the need for the user to understand the computer's internal workings or how to accomplish certain tasks. The computer acts on the ideas that the users express rather than the commands explicitly given to it. SR and NL also allow for real time language translation. The SR and NL operations can also support different languages including but not limited to English, French, German, Spanish and Italian.

As a result of utilizing SR and NL for real time language translations, the network and method of the invention gives a user the impression of listening to what the user intended and acting upon it much as another human being would. For the user, the experience is similar to interacting with the celebrity personality in real time as though in an actual live conversation.

### INTERACTIVE VOICE TECHNOLOGY SUMMARY

Voice enablement technologies will need to add to the interactivity of the digital character by providing the following abilities: speech recognition (natural), speech to text translation, text to speech translation, speech synthesis. All speech enablement will be based on VoiceML web architecture.

### Voice Recognition

Unisys' Natural Language System may serve as the main voice recognition technology used in all of the star products. A company like Nuance or SpeechWorks can provide Speech Recognition (SR) software to retrieve the phonemes for the Natural Language (NL) to filter and process. A company like Phillips will supply voice recognition services for multi-language support and VoiceXML interfacing. Its application services will be in conjunction with Unisys' NLS services for a data enriched user experience.

### Text to Speech Translation

Text to Speech will be accomplished using software development kits (SDK's) provided by a company like Lernout & Hauspie (L&H). As users request voice information not cached in the voice database, the L&H system will search, download and translate web content to speech. The L&H application services will also be utilized for voice enabled web navigation.

### Speech Synthesis

The ability to deliver web content in the voice of the celebrity without the need to cache large stores of pre-recorded responses will be essential to manage multiple celebrity profiles and constantly updated information.

With a company like Fonix, the speech synthesis input is a standard text or a phonetic spelling, and the output is a spoken version of the text.

A two-phase Speech Synthesis process will be employed:

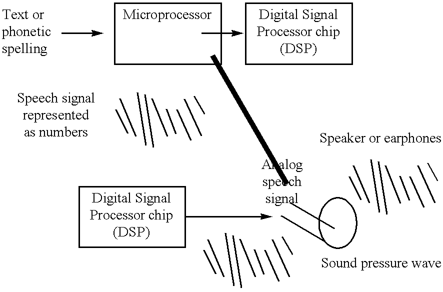

The text is converted into a phonetic representation with markers for stress and other pronunciation guides the phonetic representation is spoken. The computation can be done by a Digital signal (DSP), a microprocessor or both.

Text-to-Speech synthesis uses standard text or phonetic spelling as input. A microprocessor or DSP creates a digital representation of a speech signal. A digital-to-analog converter chip changes it into an analog speech signal, which can be played through a microphone or headset.

### KEY INTEGRATED TECHNOLOGY FEATURES

Natural Language Support

Voice Recognition (SR)

Visual and Audio Navigation

Dynamic 3D Animated Lifelike Character Creation

Dynamic Lifelike Face Creation with a 2D digital image.

Full Animated Interactivity with Lifelike 3D Characters

Voice Web Navigation

Text to Speech Translation of Web Content

Enhanced Artificial Intelligence

Enhanced Data Indexing of Voice User Session

Enhanced Datamining of User Experiences

Voice and 3D Animation Enabled E-commerce

Voice and 3D Animation Enabled Affiliate Marketing

Multiple Device Support (Desktop PC, Wireless PDA, Web Enabled Cellular Phone

User Customizable Web Content Delivery via Voice.

Participation in personalized interactive chats

Participation in personalized interactive contests, polls and games.

Live Audio/Video Conferencing with other users and celebrities.

### Voice over IP Technologies ( VoIP)

VoIP is used with the StarPass product for telecom cost efficiency. Using a VoIP based network provided by such companies as ITXC, Stars 1to1 can leverage the VoIP gateway's ability to convert analog data into digital format for better use with the Unisys NLS.

VOIP provides more efficient use of bandwidth. Data, voice, and video in packet format are often compressed. For example, compressed voice can use as little as 1/10 of the bandwidth required for normal PCM voice signals. This allows many more voice channels to be carried over a given bandwidth.

### ACCESS TO THE INTERACTIVE NETWORK

The network of the present invention may accessed by a telephone line, including via use of a backstage pass-type of pre-paid phone interaction card, or by video, CD, DVD, wireless, Internet or remote kiosk.

### Telephone Access To the Interactive System

Unlike the traditional phone card, one embodiment of the present invention provides a prepaid phone interaction card called a StarPass, that is similar to a backstage pass in that it provides an all-access conversational interaction with various celebrities. Similar to the traditional calling card, this embodiment uses a personal identification number (pin) to initiate the call. However, the pin number in the case of this embodiment of the invention is also used to track and direct the caller throughout the voice interaction.

Further, the traditional telephone calling card is primarily utilized for the purpose of placing a telephone call, either domestically or internationally, for the purpose of speaking with family, friends, and/or associates. In contrast, one embodiment of the present invention provides a prepaid phone interaction card that connects a caller directly to the interactive network providing the caller the ability to converse with their favorite celebrity, rather than using the calling card to merely make a telephone call.

One embodiment of the present invention provides a prepaid phone interaction card that uses speech recognition and natural language software to allow a caller to interact with a celebrity, unlike the traditional calling card that requires the use of dial tone method function (DTMF) for the purpose of connecting a phone call. Unlike the traditional calling card, the prepaid phone interaction card provides a caller access to the interactive entertainment network of the present invention and the ability to participate in an interactive session with a celebrity. Hence, the prepaid phone interaction card of the present invention function as a loyalty membership “backstage pass” that supplies the caller with discounts and access to special information and promotions, unlike a traditional calling card.

The StarCard of the invention is a prepaid debit card that offers a different service from most calling cards in that it is utilized to connect directly to a platform whereby the caller or user can converse with his favorite celebrity. The data collected from users, for example PIN numbers, length of calls, origination location of call, etc. can be gathered for marketing purposes. Such data can be used to increase the target market focus for contest and promotion purposes and to record the number of times the user accesses the system for pricing purposes.

Any person, or alternatively a selected demographic, may apply for a StarCard which may also be continuously upgraded in credit by calling the network or system sponsor or its affiliates such as Star 1-to-1. Stars 1-to-1 may co-brand its card with third parties such as InternetCash™ who provides an easy, safe, and private way for consumers to shop online and make purchases without using a credit card. This is especially practical for people under 18 who generally are not able to obtain credit card, or for those who have encountered bad credit or are worried about the security of making purchases on the Internet.

Consumers will be able to make purchases over the phone or Internet in the same way as if they were using a credit card. They must activate the card by inputting a PIN number into the phone system, similar to accessing the network to interact with celebrities. Another way to activate the card is by logging on to the stars1to1.com website. After “scratching” off the silver peel icon, the user creates a personal PIN.

This credit is held by a third party fiduciary and released to Stars 1-to-1 or its affiliate partners when purchases are made. There is usually a small percentage of the sale retained by the third party and the remaining portion of the sale is provided to the network sponsor Star 1-to-1's bank account.

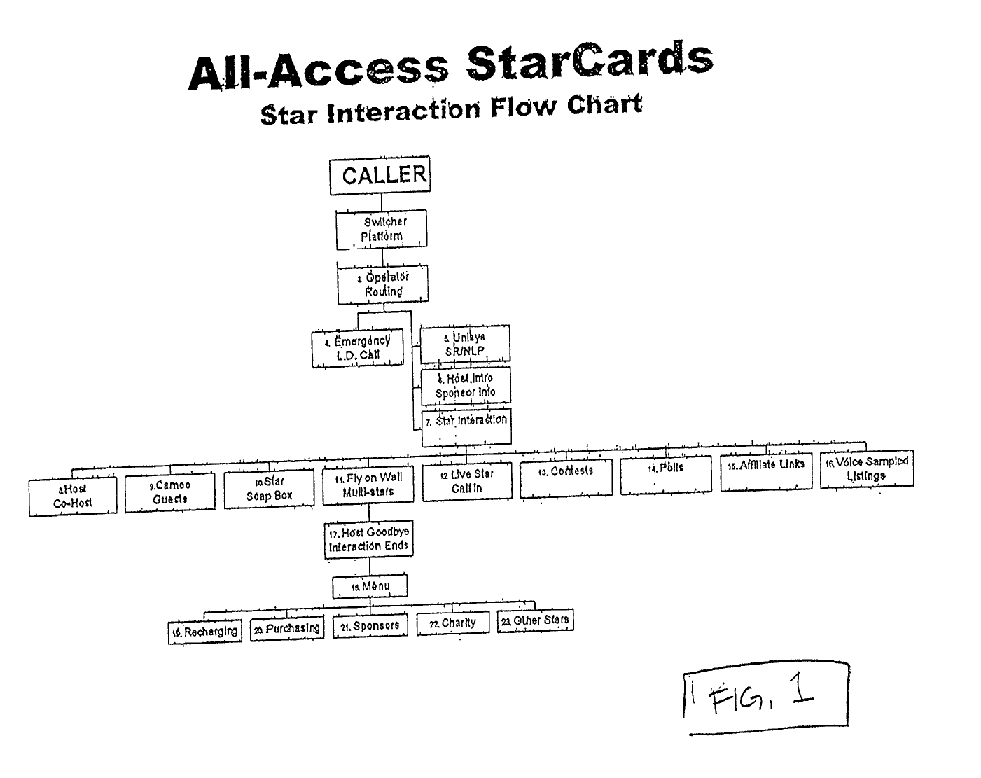

In one embodiment of the invention, access to the interactive entertainment network is provided by using a backstage pass-type of prepaid phone interaction card (also referred to as StarPass). FIG. 1 is a flow chart showing the sequence of operations of an embodiment of the present invention which is accessed by a StarPass. Where such access is provided by a phone call, the user or caller initiates a telephone call into the interactive entertainment network.

A caller accesses the network by using this StarPass with any type of phone (pay phone, home phone, cell phone, etc.), to dial a phone number to gain entry to the system. The call is immediately routed to a telephone switcher platform which routes the caller to the area they choose. In the “Operator Routing” step, the operator asks the caller to enter his PIN. The PIN is coded to signify which entertainment or information channel the caller is initially to be connected to. The caller then hears a message stating how much credit is available in his account for interacting with the celebrity/star/person/character. In the “Emergency Long Distance Call” step, the caller is given the option to use his StarPass to place a two minute phone call in case of an emergency or if they need to make a call but are lacking money or credit at the time. This feature offers parents the benefit of knowing that their children can call home from wherever they are in case of emergency. This two minute call may be sponsored by a company that includes an advertisement or logo, which reflects the sponsorship.

In the “SR/NL” operation step, the caller interacts with a chosen personality using voice response technology which combines SR and NL. A caller's question triggers the appropriate computer-generated responses in real-time without delay. The conversation is then led by the responses and carried on in a very natural manner. The call simulates a real conversation with the celebrity who, in his own pre-recorded voice or a in a simulated voice resembling that of the celebrity, gives insider information and insight about himself that will entertain, inform and enlighten the caller.

Preferably, the system includes a “Host Intro/Sponsor Info” step 6, wherein a caller listens to a pre-recorded introductory message by a host including a promotional message during the introduction in which instructions on what to do and how to use the card are provided. The host may be another well-known personality who moderates the interaction between the star or celebrity and the user. The host can for example introduce the celebrity, provide an introduction to certain portions of the interaction or interject a response when the user asks a question for which the celebrity has no previously prepared response, as will be explained below.

This embodiment of the interactive system of the present invention which may be accessed by a phone card suitable for use with a computer having the following components:

1. Intel Pentium PC running Microsoft NT;

2. IVR Platform (e.g. Parity Software Interactive Voice Response, IVR software, both commercially available from Unisys);

3. Telephony Card (e.g. Dialogic Telephony Card);

4. Natural language software package such as Unisys Spoken Language Application Development Tools and Runtime Environment commercially available from Unisys Corporation under the name Natural Language Speech Assistant (NLSA) 4.0; and

5. Speech recognizer software (e.g. Speech Recognition software, commercially available from Nuance Communications, Inc.)

### Stars 1 to 1 Hardware Requirements

Component Descriptions of the Production Environment: Company products are used as examples of the technology that is integrated.

### Telephony Gateway

Allows communication of public switch telephone network (PSTN) requests from users on standard telephones with Unisys NLSA Server. The gateway may be provided by either West Interactive or any other Gateway vendor.

### Unisys NLSA Application Server

Provides Speech Recognition, NL Processing and Content Retrieval. Provides COM bridge (means for communications) to Content Server.

### Content Server

High End Database or Filesystem server that stores all content and some application specific logic. The Disk Array File System listed below will be used for multimedia content.

### Sun StorEdge A5200 Disk Array

400 GB Capacity (22×18.2 GB drives in 1 Tabletop Array)

Sun StorEdge Management Console Software

Veritas Volume Manager Software

Users Supported: Depends on amount of Content. All content management will be done by the Entertainment server.

### Stars Entertainment Application Server

High End application server that manages integration of the VoiceGenie System.

### Sun E420 R Enterprise Server

System Chassis with 4 CPU slots, 16 memory slots, 4 PCI I/O slots, and 2 UltraSCSI disk bays, includes:

(1) 450 MHz UltraSPARC-II CPU, 4 MB E-cache

1 GB memory

(1)18.2 GB 10000 RPM UltraSCSI disk drive

Sun StorEdge DVD-ROM 10 drive

(1) 380 Watt Power supply

Solaris Server Right-To-Use (RTU)

### Voice Genie Application Server

Manages VoiceXML applications. The Unisys NLSA Server will manage all VoiceXML services.

### Sun 220R Workgroup Server

System Chassis with 2 CPU slots, 16 memory slots, 4 PCI I/O slots, and 2 UltraSCSI disk bays, includes:

(1) 360 MHz UltraSPARC-II CPU, 4 MB E-cache 256 MB memory

(1) 18 GB 100000 RPM UltraSCSI disk drive

Sun StorEdge DVD-ROM 10 drive

(1) 380 Watt Power supply

Solaris Server Right-To-Use (RTU)

One or more celebrity hosts such as Carson Daly from MTV may introduce an interaction with each celebrity. The caller's voice dictates where in the network the caller wants to go. The caller also has the option to press a key, e.g., the * (star) key, to bypass the introduction and switch over to another operation such as an interaction with a star, playing a game, making a purchase or some other operation. In the “Star Interaction” step 7, a caller speaks directly with a celebrity.

In that step the caller can ask the celebrity virtually anything she/he wants to know and will receive one response from a wide variety of pre-recorded responses. For instance, a caller can ask when the celebrity will be touring and the celebrity can respond by telling the caller about an upcoming concert or appearance in the caller's area. In the operation step 8, “Host/CoHost,” a host and/or a cohost (animated or live) can keep the conversation on track by guiding the caller through the experience in an entertaining yet useful way using, for example, lighthearted banter between the host, cohost, operator, celebrity and another person on the network. The host may be called upon to provide a response in lieu of the celebrity's response if there is a question that is difficult to answer or inaudible to the system. If the caller asks a question for which there is no celebrity response, then either the celebrity or a host will intercede and say something creative and yet personal like, “Well, excuse me . . . you know we can't answer that . . . ” and then steer the conversation by asking the caller something else like, “You can ask me about my acting career, personal interests or my new projects.” The host can also preferably redirect the caller when he asks a question for which the celebrity has no recorded answer. For example, he could state that the celebrity cannot answer that right now but let me ask you (the caller) a question. Thus the host acts as a moderator who can in essence elicit a better question from the caller or and prompt a response for which a celebrity has already pre-recorded an answer.

In operation “Cameo Guests” step 9, other stars make cameo appearances from time to time and interact with the primary celebrity and the caller in an entertaining way. In this mode, the celebrity actually participates in a real-time conversation with the caller. Other individuals may also make cameo appearances such as tour managers, family, teachers, etc. Thus, the fans can be told that the celebrity personality will occasionally participate “live” in the phone interaction phone call as a way to enhance interest in use of the network and to provide an incentive for the caller to access the network more frequently. These events can be recorded and archived for other callers to access if they wish to hear the conversation between the celebrity and a surprised caller.

In “Star Soap Box” “or StarBox” step 10, a celebrity has the opportunity to, at any time, access the network and voice any and all of their opinions or concerns. These comments could be generated in a monologue, voice-recorded format which could be periodically updated and archived and may be retrieved at the request of the caller. Various other forms of interaction with the celebrity may be selected. For example, in step 11, “Fly On The Wall—Multi Stars,” a caller is privy to a celebrity interaction with another celebrity such that the caller is like a “fly on the wall,” eavesdropping on the celebrity's intimate conversations with others which have been pre-recorded. A caller may also vote for his favorite celebrity interactions they would like to listen to. In the “Live Star Call-In” “or StarsLive” step 12, a caller talks personally with his favorite celebrity ‘live’ not computer-generated or prompted. These conversations may be randomly dispersed throughout the network and each celebrity can patch into the system at undisclosed times to talk with a lucky winner. In “Contests” operation 13, a caller can participate in interactive games and contests and have a chance to win prizes such as CDs, concert tickets, sporting event tickets, and an opportunity to meet or interview their favorite star live-in-person. In “Polls” “or StarVote” step 14, the caller votes on his favorite aspects of a celebrity's career or participates in a survey where the caller's opinion can make a difference in the celebrity's life. Information is compiled into a database and is used to improve the efficiency and response of the network or is used by a celebrity's management to improve their offerings.

Through entertaining and creative voting platforms, caller responses will be tallied and compiled into a reportable database. This information will be used by e.g., a company, celebrity, or an affiliate partners' for purposes such as marketing strategy. For example, if a celebrity is coming out with a new CD and the record company wants to know which song off the CD will qualify as the single, a survey is conducted whereby fans will hear a short segment of each song in advance of its release and vote on their favorite song which then may become the single. In step 15, “Affiliate Links,” a caller is connected to merchants or services in the entertainment industry such as TicketMaster to purchase tickets. For example, an advance version of an artist's latest single is heard or referred to and a caller is then switched over to a music retailer to purchase the CD immediately. Also, a caller can be connected to a special telephone line to order products of the caller's favorite celebrity. A caller can also receive valuable information about charities that the celebrity is associated with.

In step 16, “Voice-Sampled Listings,” a caller is kept informed and entertained over an extended period of time through various responses that deal with just about any type of interaction. This is accomplished by using Concatinate Synthesis technology, which takes a voice sample of a host's voice and creates an artificial intelligence of his or her personality to be able to have an in-depth talk with the caller without having to anticipate their every question. With Concatinate Synthesis technology, there is no need for a host or star to pre-record a response to every conceivable possible question. For example, through the use of Concatinate Synthesis software, updated information like concert dates can be provided or spoken in a star's own voice without the necessity of pre-recording the information.

The interaction with the star is terminated at step 14 of FIG. 1. in “Host Goodbye—Interaction Ends”. At this stage, the host alerts the caller that his time has or is about to expire. The host then thanks the caller for his call. Preferably the host then gives special thanks to the caller's sponsor(s) and provides a short informational message (“plus”) in support of the celebrity's favorite charity which may be a beneficiary of a portion of the call's proceeds. In “Menu” step 18, the host outlines various options as described below, that may be accessed by the caller subsequent to the initial interaction with the celebrity. In the “Recharging” step 19, the operator or host asks the caller if he wishes to speak to the star or celebrity some more and gives the caller instructions on how to order more interactive time. A caller is told that he can either recharge his StarPass using a credit card or StarCard (debit card) or can go to a local store and purchase more time. In “Purchasing” step 20, the caller is given the option to purchase the celebrity's products on the network or be switched to an affiliate to make purchases or find out more information about the availability of various products. In “Sponsors” operation 21, a caller is given the option to hear more about each sponsor and has the opportunity to be switched to the sponsor for more details. In the “Charity” step 22, the caller is told more about the charity that is linked to the celebrity and the caller can also make a donation to the charity. In the “Other Stars” step 23, a menu highlights the other stars or celebrities then available on the network. The caller is then directed to where he may purchase StarPasses, DVDs, CDs, Internet Access, and/or other goods or services.

### CD or DVD Access to the Interactive System

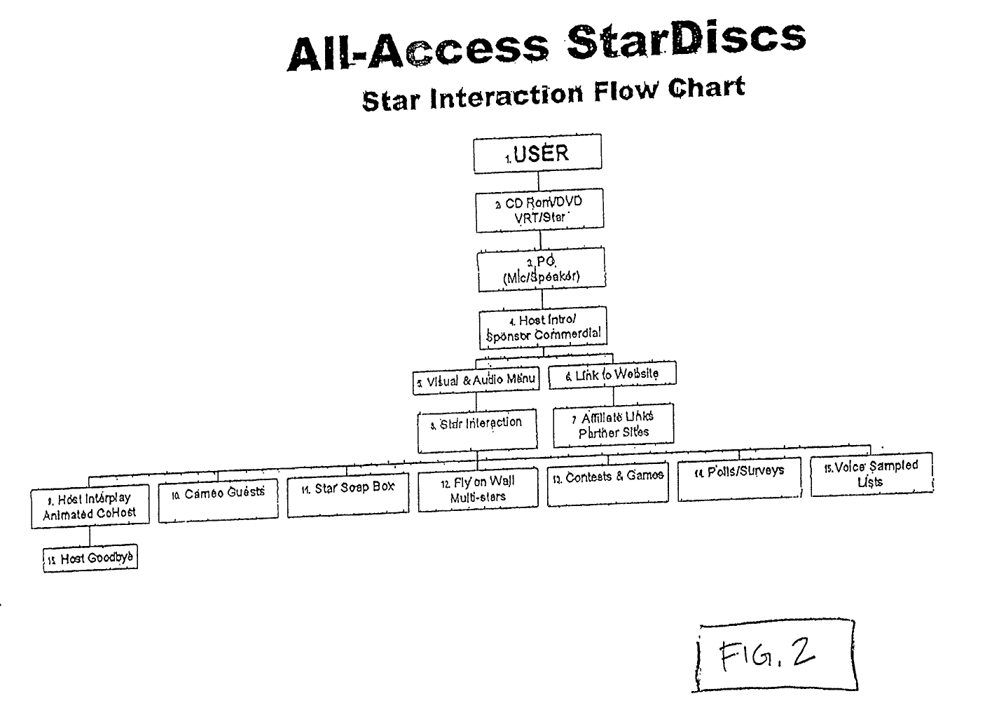

Referring to FIG. 2, the operation of an embodiment of the present invention accessed by using a CD or DVD will be described.

The user accesses the interactive entertainment network by use of a compact disc (“CD”) or digital video disc (“DVD”) for use with a computer, for example a personal computer. A compact disc read-only memory (CD ROM) is a data-storage system for personal computers using a CD on which computer programs, databases, or other large amounts of information that have been digitally encoded. Stored data often includes text and computer programs and, sometimes, pictures, sound and simple motion pictures or animation. A single, small CD-ROM disc can hold more information than 1,000 floppy discs and its advantages over LPs and audiocassettes goes beyond accuracy of sound reproduction and longer playing time. The digital signals From a CD-ROM disc provide a greater dynamic range than analog signals—90 decibels, compared to 70 decibels, there is no physical wear from the laser in a CD player and dust and minor scratches cause almost no distortion. DVDs are large laser discs that store visual images as well as sound. They are coded on both sides and outperform videocassettes. The DVD format is made up of 4 elements: video; audio; graphics/sub pictures; and programming/authoring. DVD allows for long play video and audio content that can be accessed and presented in many ways because it is stored digitally. For example, random access and interactive programming capabilities present all new experiences for existing and new content.

Referring to FIG. 2, a CD or DVD containing SR and NL is inserted into a personal computer equipped with a microphone and speaker for a visual and audio interactive experience with a star. For example, a user can ask Ricky Martin how he came up with the idea for the song, Livin' La Vida Loca. Further, Ricky may be seen in the recording studio with his headphones—after hearing the question he turns around and responds to the user's inquiry about how he wrote the song. The personal computer should have enough memory to operate the SR and NL and also be equipped with a microphone and speaker to properly interact with the network. Users insert the CD or DVD into a computer (PC or Mac) with Windows 98 or newer (preferably an NT System) and having at least 50 MB of memory such as Random Access Memory (RAM) space available. A standard computer microphone may be used. A more advanced ‘speech-recognizer-friendly’ microphone may also be used as well as a microphone such as a store bought version that singers might use. Any standard computer speaker which allows a user to hear the interaction will be sufficient.

For example, using a PC with Windows 98 or Windows NT (SP 4 or newer), the followings steps will be executed 1. Install NLSA Build 32; 2. From the Start button, invoke Programs/NL Speech Assistant 4.0/Support Tools/Install Sapi 4.0 to install SAPI and Microsoft Whisper; 3. Install Interaction; and 4. From the Start button, invoke Programs/Interaction Title/Interaction Title.

The “Host Intro/Sponsor Commercial” step 4 is similar to operation step 6 in FIG. 1. In this step, a user views and listens to a short, pre-recorded welcome message by a host including a promotional spot during the introduction with instructions on what to do and how to use the network. The user then views and listens to a message stating how much credit is available in their account for interacting with the stars. After the welcome message, the user's voice dictates where in the network the user wants to go. The user also has the option to bypass the introduction and switch over within the network to another operation such as an interaction with a celebrity, playing a game, and making a purchase. During a Host's welcome introduction, a menu is provided which gives the caller an opportunity to route himself to other areas by asking to do so. For example, a caller may say “I want to play the trivia game now” and the caller is then immediately transferred to the game area. Repeat callers can simply say what they want to do at any time during the call and they will be transferred to the area they desire.

If the user elects to stay within the network, he or she will next see and hear a visual/audio menu in step 5, “Visual & Audio Menu.” The menu lists the options available during the interaction. This includes the primary celebrity interaction from the CD/DVD purchased, as well as a list of other links including the website where the user can become a member of the network and gain access to the entire stable of celebrities on the network. Finally, the menu highlights the other stars who are available on the network, and directs the user to locations to where the user may purchase an interactive phone card or CD, DVD or Internet Access to interact with the stars. If the user elects to link to the website, in step 6, “Link to Website,” the CD or DVD provides the user with Internet access and a website to download updated information about the celebrity they've selected. The website also gives the user certain interaction options for interacting with the stars. Those options (Steps 9-16) are analogous to Steps 9-16 of FIG. 1. The “Affiliate Links” step 7 is similar to step 15 of FIG. 1. In this step, a user is connected from the website directly to links for ticket sellers such as TicketMaster. The “Star Interaction” step 8 may be accessed directly from the menu and is similar to step 7 of FIG. 1. In this step, a user asks questions directly with celebrities from various aspects of entertainment and sports via microphone attached to the PC. Pre-recorded responses are seen and heard in real-time digital video and audio. The user can also scan in a photograph of himself and be digitally placed within a scene or within a game with the celebrity.

This feature is accomplished by using a digital analyzing software (DAS) developed and owned by Cyber Extruder. DAS converts a two-dimensional image such as a passport photo or other clear front view photo, into a fully developed three-dimensional model or mask. DAS starts with a general outline drawing of a human face which is laid over the scanned image and adapts itself to conform with the facial features within seconds by using a series of algorithms. DAS then figures out what the profile and even the back view of the head would look like using mathematical comparisons similar to most humans. DAS then fills in the fleshy areas of the face using a sample of the person's skin, generally from the cheek area, to maintain a consistent look. After that process has been completed, the user is left with a three-dimensional mask that can be applied to any digitized body that has been created within the Interactive Network. For example, the user can be singing on stage with Britney Spears or doing a scene with Arnold Schwarzenegger in a film. A user may also interact with his favorite celebrity using a video of the user which can be combined within the celebrity scenes as well. The video images are captured and digitized at which point, each frame can be separately analyzed and by using DAS, a three-dimensional moving image is developed similar to animation-roto-scoping. This digital animated image can be overlaid on top of existing video footage that has been digitized as well and the two images seamlessly appear to be acting together. The scaling and perspective is processed by DAS for various camera angles like close-ups, wide-angles and long shots.

In another embodiment, “Disc Enhancements”, existing music CDs may be enhanced with a Voice/Video Interactive Experience (VVIE) whereby users interact with artists on a CD and see and hear interesting topics pertaining to a release. This is accomplished in the same manner as in the StarDisc whereby a user can have a visual and audio interaction with the celebrity. Each video and audio response is prompted by the user's questions or comments and is seen as fully integrated video images. The only difference between the StarDisc and the Disc Enhancement is that the interaction application and the necessary interactive voice recognition (IVR) software to run it is directly burned into the existing CD or DVD discs. The Music or Film Disc is inserted into a person's computer and the interaction is carried through as previously stated. This may be in the form of a welcome introduction by the celebrity or this may also include a behind-the-scenes look at how the songs were recorded, a clip of the music video or a fun interactive game where users can customize their own experience. Likewise, DVD may also be enhanced to contain video and audio interactions on the video disc itself.

### Internet Access to the Interactive System

In order to allow access to low bandwidth users, ‘Bursting’ technology can be used to quad stream audio and video files. In quad ‘bursting’ streaming, as one section of a stream is played, three other sections are automatically downloaded to the users cache. The Bursting network also routes requests using the closed access point to the user. The originating server sends all the necessary data to the access point over a high speed network relieving the need for the user to travel across large networks for access to data. Bursting technology also presents compatible compression codecs for audio and video. Accessing all the benefits of bursting will allow the Stars Interactive Entertainment Network to provide users with interactive connections at data rates as low as 56 Kbps.

‘Bursting’ ensures reliable, high quality video and audio—using industry standards players like Windows Media. Unlike Real-Time Streaming, Bursting delivers video to audiences ahead of time so that their viewing experience is smooth and continuous. Bursting technology currently supports quad streaming and supplies its own windows media plug-in. Stars 1to1 will need to have this plug-in or similar technology supported by its player.

One feature that sets Bursting apart from real-time streaming solutions is its ability to cache data to client disk buffers in Faster-Than-Real-Time. Servers “burst” multimedia data across the network into configurable client buffers at a rate faster than the play rate. Client-side players read the data from their local buffers, enjoying images and sound that are insulated from network disruptions.

### Bursting Architecture

The Bursting architecture is tailored to address specific problems of streaming latency, offering sophisticated bandwidth management, reliable failover, and delivery optimized for large files.

The Bursting architecture manages the network system as a whole, not just individual client-server relationships and tracks bandwidth usage across all of its servers and distributes client requests accordingly. Because Bursting monitors bandwidth availability across the whole network, it can optimize allocation of network resources, resulting in greatly increased network efficiencies. These efficiencies allow Bursting to service more users for the same cost.

Bursting Servers apply a need-based model, tracking the buffer levels of each client they service and alotting bandwidth based on need. Clients whose buffers are running low are serviced before clients whose buffer levels are higher.

Multimedia files are isochronous, or time-based. This means that if data is lost during transmission, the application cannot simply resend the file from the beginning.

Bursting offers the necessary failover that time-based data demands, with uninterrupted service should a server, conductor, or network component go down. Using backup servers and conductors, and synchronizing all delivery components, Bursting ensures that a video or audio file will continue playing uninterrupted should any single component fail.

Bursting is optimized to handle large files. Sending data in regulated bursts, Bursting varies the size of the burst according to bandwidth availability at a particular moment. Because the buffer size is configurable and not tied to the size of the media file, the client machine is not required to accommodate the entire media file, easing storage requirements.

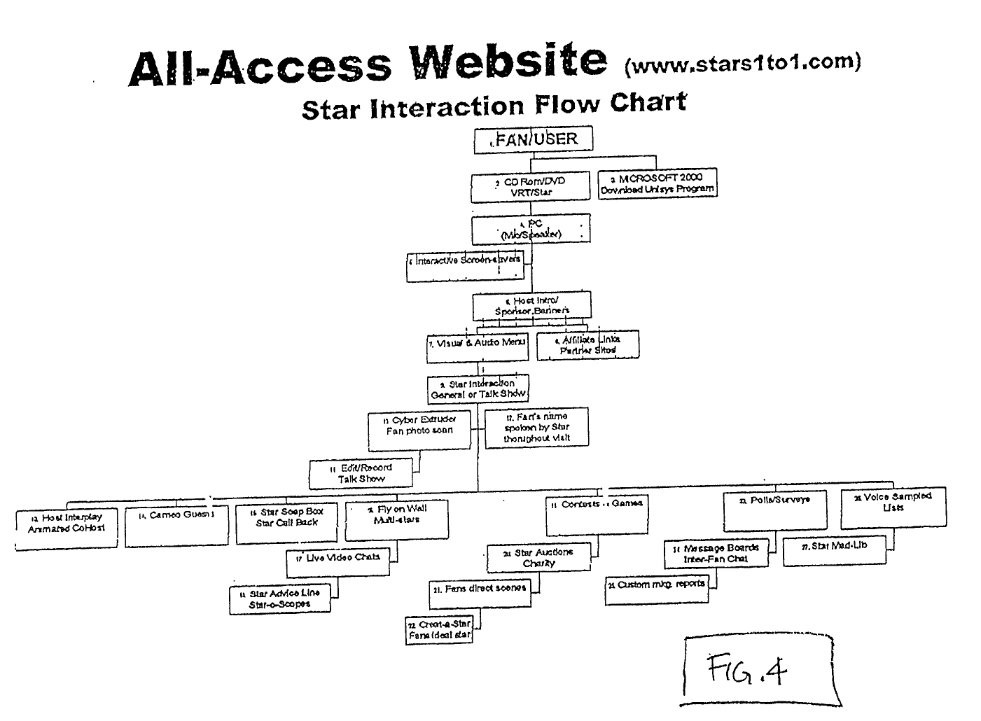

Referring to FIG. 4, the operation of an Internet embodiment of the entertainment network of the present invention is described. A user accesses the interactive entertainment network through an Internet website on a computer such as a personal computer. A visitor to the website can speak through his computer microphones to have a full-voice-interaction with his favorite celebrities. Similar to FIGS. 1 and 2, the CD or DVD containing SR and NL are loaded onto a personal computer equipped with a microphone and speaker. The CD or DVD contains the SR and NL necessary to run the application along with the Internet simultaneously or the user can upload the software into his computer and run the application without the CD ROM. The user can utilize the Microsoft 2000 program to download the necessary software to his computer from the network developer e.g., stars1to1.com website or from Unisys or other speech-recognizer vendors. A fast modem is preferred (56k or faster) to effectively run the application.

Once on the website, the user's questions or commands guide him and he controls his own experience. The user navigates through the website by using simple voice commands like, “Take me to the music area” and “I want to talk with Britney Spears.” For example, the user can then watch a full motion video streamed image of Britney welcoming him to ask her a variety of questions. The user can also be hyper-linked to the celebrity's official website (e.g., www.britneyspears.com) for more information or to other affiliate sites to purchase products or play games. In the “Microsoft 2000” operation step 3, a user can download the SR and NL directly from the network developer's website or from another site such as that of Unisys Corp.

In the “Interactive Screen-Savers” step 5, a celebrity's image is animated and moves across the computer monitor screen as a screen saver. The user can also scan his or her photo into the system using for example Cyber-Extruder software (DAS) commercially available from Cyber Extruder or from Stars 1-to1's products or services through a special licensing agreement between Stars 1-to-1 and Cyber Extruder, and have the user's image animated in the screen saver along with an image of the star.

The screen saver itself is voice-enabled so that the user can ask questions like, “What time is it?—“Do I have new mail” etc., and a response to the user's question is generated in the celebrity's voice. Computer-generated Steps 6 through 9 are similar to the operations with the same name in FIG. 2. In the operation step 10, “Cyber Extruder Fan Photo Scan,” the user scans in a photograph of himself, a 3-dimensional mask is created and the fan is digitally placed within a scene like a personalized talk show with their name on the marquee. The user can choose a specific body type and outfits and can be seen for example singing on stage with a celebrity such as Britney Spears or doing a scene with Arnold Schwarzenegger in the film the Terminator.

Users can also interact with their favorite celebrity using a video of the user combined within the celebrity scenes. In “Edit/Record Talk Show” step 11, interactions may be edited and saved onto a CD, DVD, computer diskette or emailed to others. In “Fan's Name Spoken by Star Throughout Visit” operation 12, the user inputs his or her name and other information (e.g., user name, password, etc.) and throughout the interaction visit, the host and/or celebrity will address the user by his name. An opt-out feature allows a user to confirm or change the name entered into the system. The names are voice sampled and translated into the celebrity's or host's voice by the computer using Concatinate Synthesis technology. Steps 13 and 14 are similar to the steps in FIG. 2 having the same name. In “Star Soap Box/Star Call-Back” or “StarBox” step 15, a star may access the network and voice any and all of their opinions or concerns for all the world to hear and see. The comments are updated and archived and may be retrieved at the request of the user via a search engine on the website. The “Star Call-Back”, “StarBox” operation gives the fan a chance to get a live or voice interactive phone call or email with personalized greetings like “Happy Birthday,” “Congratulations on your graduation,” etc.

The “Fly on the Wall—Multi Stars” step 16, is the same as the step of FIG. 2 of the same name. At scheduled times, stars will conduct live interviews with selected fans on the network in “Live Video Chats” step 7. This is seen and heard through video streaming.

From time to time celebrities will enter the network using an access code that is provided to them. A celebrity, using his own phone, is linked to one or more callers who are randomly selected by software. Transcripts or video recordings are archived and available for downloading. In step 18, “Star Advice Line/Star-o-Scopes,” a user can ask a wide range of topical ‘teen’ questions and a choice of various celebrities are shown to the user with the answers to their questions. Star-O-Scopes also features a star or a fan's astrological daily information. Step 19, “Contests & Games,” is similar to step 13 of FIG. 2. Any game can be altered using Cyber Extruder's DAS. The user can insert himself into the game and put his face over an existing computer game body. The celebrity will also have his face applied to another computer body and the user then can control what his ‘character’ does within the game.

“Star Auctions/Charity” at step 20 is a feature that permits holding periodic auctions of celebrity memorabilia. A user will either bid on items while being linked to other existing Internet auction sites, given the opportunity to bid through co-branded web auctions or bid through Stars 1-to-1 auction through licensed auction software like OnSite. In “Fans Direct Scenes” step 21, a user scans or digitally uploads his image into the system and the image is inserted into a scene of his choice and then the user can voice-direct the scene. The user then can create his own music video or a scene from a movie or be in a sports stadium playing with a star. The user can also direct the scene of his favorite celebrity without his own image in the scene. These interactions can be edited, recorded and downloaded or emailed to others.

In step 22, “Create-a-Star/Fans' Ideal Star,” a user gives voice commands of the attributes of his ideal celebrity in various entertainment and sports categories. A customized character is then directed in various scenarios or the user can play a game with the customized character. A fan can scan his image into the scene as well. Step 23, “Polls/Surveys,” is similar to step 14 of FIG. 2. In step 24, “Message Boards/Inter-Fan Chat,” a user leaves messages for their favorite stars or for other users. A user can also chat with other users of a particular celebrity. From data collected about Internet usage and the results of the polls, surveys and contests, a report is made in “Custom Marketing Reports” step 25. “Voice-Sampled Lists” step 26 is the same as step 15 of FIG. 2. In step 27 “Star Mad-Lib”, a star reads a paragraph and leaves blanks to be filled in by the fan. The celebrity prompts the user for a noun, verb etc. The words filled in by the fan are then translated into the voice of the celebrity and read back to the user using voice-sampled Concatinate Synthesis software.

The following examples illustrate the entertainment network in accordance with the invention.

### EXAMPLE 1

### Community—Fans Interacting with Each Other and the Stars

An Internet community site where people with shared interests in celebrities interact with each other as well as with the celebrities themselves is provided. This includes forums, chat rooms, message boards, updated information, e-commerce, links to related sites, etc. Features of the community site include: Games, Contests, Trivia, etc.—StarStakes; Polls, surveys and voting for favorites; Links to make purchases from affiliate partners; Updated messages from stars from Stars Soap Box (downloadable); Live scheduled Video chats with stars; Celebrity Auction with part of proceeds going to charity; Star screen savers that interact—celebrities tell time, welcome, you've got mail, etc.; How well do fans know their stars? Show topic or answer and celebrities guess which star it belongs to. Also celebrities hear a voice and guess whose it is; users write and direct their script with the stars interacting with them as supporting actors. Using voice commands actors move through scenes like dolls; ‘Stars Mad-Lib’ Fans fill in the blanks of a paragraph read by a star then star reads back using voice sampling; and users are ‘Flies on the Wall’ watching celebrities interacting with each other.

### EXAMPLE 2

### Interactive Talk Show Along with Animated Co-Host (and/or Celebrity Host)

Fans can log-on the site and access a full stable of celebrities who they can interact with. A user hosts their own custom talk-show where the user chooses the guests, asks the questions they want to get answers to, views video clips and participates in fun interplays with contests, games and other interactive activities. A user can also scan his photo or video into the system and be seen on the virtual talk show stage. Features of the Interactive Talk Show include: All-Star City—Visual menu like Hollywood squares—Static photo turns live when that person is addressed; ‘Be-a-Star’—User can virtually be inserted into scenes with stars. User can download recorded interactions; and ‘Create-a-star’—User create their ideal star using voice commands—a customized star emerges both visually and via audio.

EXAMPLE 3

### Fan Entertainment Club—A Portal of Fan Clubs

A fan entertainment club is provided where members can take advantage of many benefits such as an all-access pass to the network, discounts on products and services and eligibility to special contests and promotions. The members are the people who purchased any product or service of the network or a subset thereof. The fan clubs of the individual celebrities will provide the network with updated content and assistance in research and development of celebrity products. There will be a directory containing direct links to the fan club sites for more information. Features of the membership entertainment club opportunities include: members register and give their name which is then spoken by the celebrity throughout visit; power buying specials; user receive & record star greetings such as happy birthday, graduation, holidays, etc.; and users are profiled and buying habits noted-they are directed to links and pages they want to see.

### EXAMPLE 4

### StarAdvice

This thematic option is a culmination of pre-recorded responses relating to various topics that a user is interested in. The celebrity response is voice-prompted in the same manner as the typical interaction. However, a menu is presented to the user to let him know which topics are addressed by the celebrity.

In this embodiment of the invention, a user asks a celebrity about dating, opinions, fashion, favorites topics, etc. Features of StarAdvice include: How To (craft) Tips from Stars (sing, perform, play sports, etc.); Celebrity Hotline (Hot Spot)—Celebrity Chit Chat—StarWatch; users ask general questions pertaining to their interests (musician asks about singing and each celebrity appears with different answers). Users can also post answers for stars to address later; show a percent answered by stars to certain questions—Best of categories; and Star-o-Scopes—Celebrity Horoscopes and fan horoscopes as well.

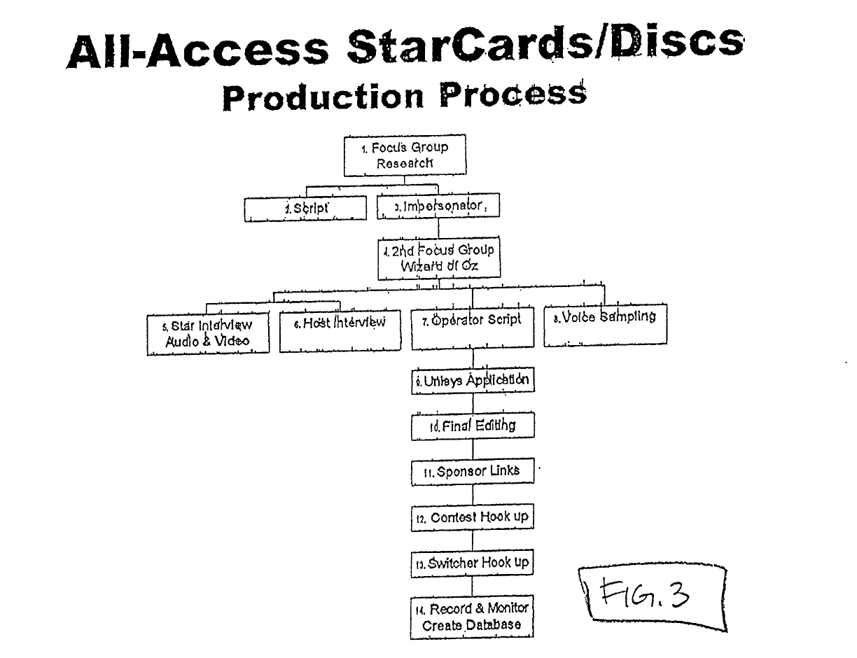

Another embodiment of the present invention involves a production process for creating and monitoring the database of responses provided by a celebrity or star. Referring now to FIG. 3, the production process will be described. It should be recognized that the database created as a result of this process forms the basis for the celebrity's responses in the interactive entertainment network regardless of whether those responses are accessed via telephone, CD or DVD or via the Internet.

Focus group research is performed with respect to a particular celebrity or group of celebrities as shown in step 1 of FIG. 3. A focus group is a sample of individuals who have the characteristics (e.g. age, gender, interests) of the persons regarded to be of interest or who may typify of the fans of the celebrity. The focus group will then be gathered together and will be asked a series of questions or have other discussion intended to elicit a script of, for example, most commonly asked questions of the celebrity, step 2. The script may also identify areas of interest in the celebrity's life, activity, schedule, favorite roles, etc. which can serve as a platform for identifying topics of interest about the celebrity.

Once those topics or script have been identified, an actor is hired as shown at step 3 of FIG. 3 to impersonate the celebrity. Next, a second focus group is held before a similarly constituted sample of the public in a format where the impersonator remains hidden from the group. That format, where the impersonator remains hidden from the focus group but responds to questions from “behind a curtain,” is referred to as the Wizard of Oz format. This Wizard is actually a live technician who prompts the appropriate pre-recorded responses (from the impersonator) to a live focus group participant. In this case the Wizard takes the place of the finalized NL application. This approach enables the team to record and analyze how the interaction takes place with a minimal expense. (step 4). A refined set of topics and scripts based on this second focus group is then generated. This data is then used to fine-tune the scripting and speech-analyzers so that by the time the celebrity and/or host record and the final application is complete, most of the errors have been eliminated.

Once the refined script has been generated, an actual interview (both audio and video) of the celebrity is conducted and recorded as seen in step 5 of FIG. 3. Preferably, an interview of the celebrity by a host or series of hosts is also conducted (step 6) to generate the host-facilitated portion of the interaction. The voice response by the celebrity will then be generated either via use of an operator script or voice sampling techniques.

Voice sampling is a technique where the computer actually constructs the answer and generates a response in the voice of the celebrity. Concatinate Synthesis technology such as that which is available from the Lernout and Hauspie company is used in a preferred embodiment. Once all of the sounds that the celebrity could utilize to formulate a response have been recorded, the computer can generate a response using those sounds in the appropriate sequence. Thus, once the computer has determined what the correct answer is, it combines the sounds in the correct sequence for a response in the celebrity's own voice. It will be appreciated that voice sampled responses are most effective for use with responses to factual questions asked of the celebrity e.g. “Where were you born?”, “When is your next concert in Chicago?”, and “Where can I get tickets?” For the response to these types of questions, the computer does not have to formulate anything other than a known response to an objective question.

Where the inquiry is of a more personal nature or calls for an opinion, e.g. “Do you think we can solve the problem of global warming?”, and “What is your favorite color?”, it may be undesirable or impossible to have a computer generate the response. Thus, a pre-recorded response by the celebrity is more appropriate and preserves the integrity of the interaction, i.e. it gives the celebrity's actual belief or opinion. As seen in FIG. 3 at step 7, an operator script can be generated from the celebrity and host interviews and the recorded operator script then prompts the computer for the same response in the user's own voice.

As seen in step 8, voice sampling technology is an alternative source for the celebrity's response. The sampled sounds (scripted vowels, consonants, syllables, voice patterns, etc.) are stored in compiled databases. The final responses are not pre-stored but are computer-generated by the Concatinate Synthesis software combined with pre-scripted variables so that the software can better formulate the responses using the celebrity's (or fictional/animated characters) voice. Once the operator script has been finalized, a Unisys natural language application will be applied to that script in accordance with step 9 of FIG. 3.

In another embodiment, the invention consists of a system for redirecting the interaction with a user who asks a question that the system cannot answer. As described above, the system may preferably generate responses to user inquiries from voice sampling data or from pre-recorded messages. It is possible, however, that some users may ask a question for which there is no pre-recorded message or other answer. In such instances, the system of the present invention contemplates use of a host who has introduced the celebrity [step 6 of FIG. 1, Step 4 of FIG. 2 and Step 6 of FIG. 4] to intervene and direct a question to the caller. For example, the host may say, “the celebrity can't answer that question but why don't you ask her about her upcoming concert.” The host or celebrity may alternatively ask the user a question which elicits a response that the celebrity has anticipated and for which a pre-recorded answer is provided. In this way, the system maintains the interactive aspects of the discussion and elicits a better question from the user. Alternatively, the celebrity can supply a pre-recorded response stating that she cannot answer that question and the celebrity or star may himself redirect the user to ask another question.

Alternatively the system or network of the invention facilitates an interaction between a user and a politician, author or other well-known person, or even the sponsor of an event that the user has an interest in. The pre-recorded voice of the well-known person could be used for responses in a manner similar to what has been described above for a celebrity interactive method, system or network. Such a network or method may be used to inform, instruct or provide other guidance to a user and may be a desirable way to impart information, particularly where the well-known person has a distinctive voice.

Obviously, numerous modifications and variations of the present invention are possible in light of the above teachings, and additional aspects and features of the invention will be apparent to those of skill in the art.

### Wireless Access To The Interactive System

The Stars 1-to-1 StarDisc or StarPass are applicable to wireless devices enabling users to have a voice and/or voice-visual interaction with a celebrity or Avatar. Avatar, as used herein, refers to a virtual image or other sensory representation of an actual or artificial person, personality or character. The interaction can be driven over any wireless device including but not limited to cell phones, PDAs, laptops, etc. Users can link up to the Internet for updated information driven by pre-recorded responses or text to speech responses.

### Voice Assistant

A voice activated hand-held or hands-free service that allows the user to voice-direct their wireless devices to make calls, set reservations, appointments, call back user as a reminder, send emails and anything else that can be done by making a call.

### Celebrity or Virtual Assistant Wireless Voice Mail Host

A favorite personality will answer the user's cell phone when the user is not available and take messages in an entertaining IVR environment.

### The Celebrity or Virtual Assistant Wake-Up & Reminder Service

A personality calls the user's cell phone to remind them of an appointment.

### Wireless Face-Mail

The user can, within seconds, create a 3D face mask of themselves, scan it in put it on an avatar and the avatar will then speak the voice message being sent.

### Games

By utilizing IVR for simple games. The user can voice interact with other users simultaneously sophisticated games the player's experience will be enhanced and more player friendly.

### Product Purchases by Wireless

This service puts the user in contact with a retailer and, through interactive conversational voice, they can ask a number of questions to select the products of their choice.

They could ask to hear a piece of a song from a new album before ordering, have it shipped, and charged to their wireless bill.

### Interactive Remote Kiosk Access To The Interactive System

A remote voice/visual interactive application that is customized to a fast-food restaurant such as Checkers, McDonalds and Burger King in which an avatar or person takes orders over the wireless and also at the drive-through location. The computers will reside on the premises of retail stores, restaurants and/or amusement parks. GPS may be linked to the order-fulfillment process but is not required.

### BUSINESS TO BUSINESS (B2B) APPLICATIONS

The invention is also applicable to an out-sourced service bureau option for the development of customized marketing, recruitment, training and promotional applications. By utilizing voice-recognition, video/audio streaming, artificial intelligence and animation (‘voice-hosting’), StarPlayer's interactive solutions can invigorate its clients' strategic efforts and provide personalization, speed, intelligence, efficiency, visitor retention, repeat customers (“stickiness”) as well as cost savings. Target markets of its services may be large corporations as well as medical, recruitment, government and educational institutions. Customized front-end applications can be created to provide virtual service-people such as WebHosts, SalesBots and Customer ServiceBots that voice-interact with users. These 3D animated characters (realistic or animated) also act as a sophisticated search-engine leading users throughout Web sites via voice commands. The StarPlayer also allows users to place 3D images of themselves into virtual environments interacting with other characters, scenes and products.

It should be understood that the above examples are meant to be illustrative and not limiting. Accordingly, any suitable combination of computer readable instructions directing at least one computer processor to perform the steps of the invention is within the scope of the invention. Moreover, any suitable sorts and configurations of hardware, including computer-readable memory, as well as any suitable sort of means of network or non-network communications are within the scope of the invention.

We claim:

1. A computerized method for interaction between a user and a virtual personality comprising the steps of:
a) storing in a database data relating to a personality's responses to various inquiries;
b) prompting a user to provide a speech comment directed to the personality;
c) detecting the user's comment using speech recognition software;
d) interpreting the user's comment as an inquiry based on natural language processing of the detected comment;
e) processing the inquiry and the stored data in the computer to generate a personality response to the inquiry; and
f) transmitting the response to the user in the personality's voice.

2. The method of claim 1 wherein the user is prompted via telephone access, wherein the access is granted in response to use of a calling card device assigned to the user.

3. The method of claim 1 wherein the user is prompted via use of a CD.

4. The method of claim 1 wherein the user is prompted via use of a DVD.

5. The method of claim 1 wherein the user is prompted via use of web pages delivered via the Internet or another communications network.

6. The method of claim 1 wherein the user is prompted via the use of a wireless device.

7. The method of claim 1 wherein the user is prompted via the use of a remote kiosk device.

8. A computer system for interactive communication between a user and a virtual personality comprising:
a) means for storing in a database voice responses of a personality to inquiries;
b) means for detecting a user's speech directed to the personality;
c) means for interpreting the speech to formulate a user inquiry;
d) means for accessing in the database an appropriate personality voice response to the user inquiry; and
e) means for transmitting the personality voice response to the user.

9. The computer system of claim 8, further comprising:
a) means for determining if the user inquiry has a corresponding personality voice response stored in the database;
b) means for storing in a second database the voice responses of a host;
c) means for accessing the host voice responses in the second database if there is no corresponding personality voice response to the user inquiry; and
d) means for transmitting the host response to the user.

10. A method for creating a database of personality responses to commonly asked questions which comprises the steps of:
a) conducting one or more focus groups with members of the public to generate one or more sets of questions commonly asked of the personality;
b) recording an interview of the personality responding to one or more of the questions;
c) recording one or more voice samples of the personality;
d) storing the interview responses in a database in relation to the information requested by the corresponding questions; and
e) storing the voice samples in the database.

11. A computer readable media for directing at least one computer processor to perform the steps of:
a) storing in a database data relating to a personality's responses to various inquiries;
b) prompting a user to provide a speech comment directed to the personality;
c) detecting the user's comment using speech recognition software;
d) interpreting the user's comments as an inquiry based on natural language processing of the detected comment;
e) processing the inquiry and the stored data in the computer to generate a personality response to the inquiry; and
f) transmitting the response to the user in the personality's voice.

12. A computer-enabled entertainment network for interactive communication between a user and a personality comprising:
a) means for storing in a database voice responses to inquiries by a personality;
b) means for identifying a user inquiry;
c) means for accessing in the database an appropriate voice response to the user inquiry; and
d) means for transmitting the voice response to the user.

13. The network of claim 12, wherein the means for transmitting the voice response to the user transmits the voice response as part of an audio-visual presentation of the personality.

14. The network of claim 12 or 13, further comprising means by which a user selects a personality to interact with from a plural set of personalities.

15. A computer-enabled method of transmitting information to a recipient comprising the steps of:
(a) providing means by which the recipient selects a personality from a plural set of personalities; and
(b) transmitting the information at least partly in the voice of the personality selected in step (a), to the recipient, via a communications medium or network.

16. The method of claim 15, further comprising the step of:
providing means by which the recipient is able to select the type of information to be transmitted.

17. A computer-enabled system of transmitting information to a recipient comprising the steps of:
(a) personality selecting means by which the recipient selects a virtual personality from a plural set of virtual personalities; and
(b) information transmitting means for transmitting the information to the recipient, via a communications medium or network, at least partly in the voice of a personality selected by recipient using the personality selecting means.

18. The system of claim 17, further comprising:
information selecting means by which the recipient is able to select the type of information to be transmitted.

19. A method of interacting with a virtual personality comprising accessing, as a user, a system according to any one of claims 8, 9, 17 and 18, so that requested information is transmitted to the accessing user at least partly in the voice of the personality.
